(19) United States
(12) Patent Application Publication
(10) Pub. No.: US 2006/0206821 A1
(43) Pub. Date: Sep. 14, 2006

(54) Data moving method and user window interface

(75) Inventor: Huan-Wen Chien, Taipei (TW)

Correspondence Address: BIRCH STEWART KOLASCH & BIRCH, PO BOX 747, FALLS CHURCH, VA, 22040-0747, US

(73) Assignees: GIGA-BYTE TECHNOLOGY CO., LTD.; GIGA-BYTE Communications, Inc.

(21) Appl. No.: 11/073,695

(22) Filed: Mar. 8, 2005

(51) Int. Cl. G06F 9/00

(52) U.S. Cl. 715/733; 715/748; 715/764; 715/835

(57) ABSTRACT

A data moving method and a user window interface used in general computer operating systems or portable electronic systems for moving, copying, cutting, or pasting files or folders in a one to many, many to one or even many to many manner. The user window interface comprises a data source area in which at least one source file or source folder is selected, a data target area in which at least one target data folder or target disk drive is selected for accommodating the source file or source folder to be moved, and an instruction control area in which at least one instruction for moving the source file or source folder is directed so that the source file or source folder may be moved to the target data folder or target disk drive in a one to many, many to one or many to many manner.

### BACKGROUND OF THE INVENTION

1. Field of Invention

The invention relates to a user window interface used with an operating system (OS), through which at least one file or folder thereon may be cut or copied into at least one folder, directory or data disk drive in a one to many, many to one or even many to many manner.

2. Related Art

For current computers or operating systems (OSs), only those files or sub-folders in the same folder may be selected when they are to be moved, copied, cut, or pasted to a target position. The target position may be a folder in the same computer, a position under a disk drive root directory, or the like. The target position may also be a folder in another computer or a server that may be accessed through use of the Internet, a local network, or the like. Based on this method of moving data, messages, communication books, calendars, and the like in a mobile phone system are generally moved and arranged internally or moved externally to a home computer or another mobile device.

However, data moving or transferring operations and required instructions have to be carried out in a step-by-step manner. For instance, when files in different folders will be moved, only a/several file(s) in a folder may be selected and moved to a target position by issuing an instruction for file moving. Other files in another folder to be moved have to be operated successively by executing the same operations. When files in the same folder are to be moved to different folders, these files may be moved into their respective target folders by only being individually selected and moved those files to put in the same target folder. Then, files to be moved into each of other target folder(s) are selected and moved with the same process.

Such a selection method is troublesome and inconvenient to the user, particularly in mobile phone applications.

Now, an example is given for illustrating a process of the prior technology described above with respect to data moving on an operating system (OS) where a plurality of data sets are to be moved to a plurality of target positions. A flowchart illustrating the prior data moving technology is shown in FIG. 1. In this example, a folder C:\windows is to be cut and pasted to a target folder D:\peter and also copied to a network data folder \\192.168.10.23\share, and a file C:\windows\kk.dll is to be copied to the folder \\192.168.10.23\share. In so doing, the user enters a directory C:\ first and then gives an instruction to cut the folder “windows” (Step 902). Next, the folder D:\peter is located and an instruction is issued to paste the folder “windows” to the folder D:\peter (Step 904). Then, under the directory D:\peter an instruction for copying the folder “windows” is sent (Step 906). Thereafter, the folder \\192.168.10.23\share is located and an instruction is issued to paste the folder “windows” thereto (Step 908). Then, the folder D:\peter\windows is located and an instruction to copy the file kk.dll is sent (Step 910). Finally, the folder \\192.168.10.23\share is located and an instruction is issued to paste the file kk.dll to the folder \\192.168.10.23\share (Step 912).

Although those files and folders may be moved according to the issued instructions, the process is inefficient. Furthermore, before an instruction is issued, a determination has to be made as to whether the involved folder or file has been moved to the prescribed position.

Therefore, there is a need to provide an efficient data moving method and a user window interface therefor.

### SUMMARY OF THE INVENTION

To address the problems in the prior art, the invention provides a user window interface through which a plurality of data articles (files or folders) may be moved to a plurality of target positions at the same time so as to simplify the operating process of data moving. The invention comprises a source directory frame showing all files and folders in a computer or handheld device upon which a user selects at least a data article intended to be moved, a source display frame on which a data article selected in the source directory frame is displayed, a target directory frame showing all target positions upon which the user selects at least one target position for accommodation of the data article intended to be moved, a target display frame on which the target position selected in the source directory frame is displayed, and a plurality of instruction control buttons including a confirmation button and a cancel button through which the user selects an instruction for moving the selected data articles. The selected data articles displayed in the source display frame are moved to the target position selected in the target directory frame and displayed in the target display area.

The invention also discloses a method of moving a data article at the same time on the user window interface, comprising the steps of providing a source directory frame and a source display frame, selecting a data article intended to be moved in the source directory frame, displaying the data article selected in the source display frame, providing a target directory frame and a target display frame, selecting a target position in the target directory frame for accommodating the data article, displaying the target position selected in the target directory frame on the target display frame, selecting an instruction in the instruction control area and moving the data article as selected to the target position.

The features and implementations of the invention will be described below with reference to the preferred embodiments in connection with accompanying drawings.

### BRIEF DESCRIPTION OF THE DRAWINGS

FIG. 1 is a flowchart illustrating a prior data moving technology, wherein a plurality of files or folders is moved to a plurality of folders or directories;

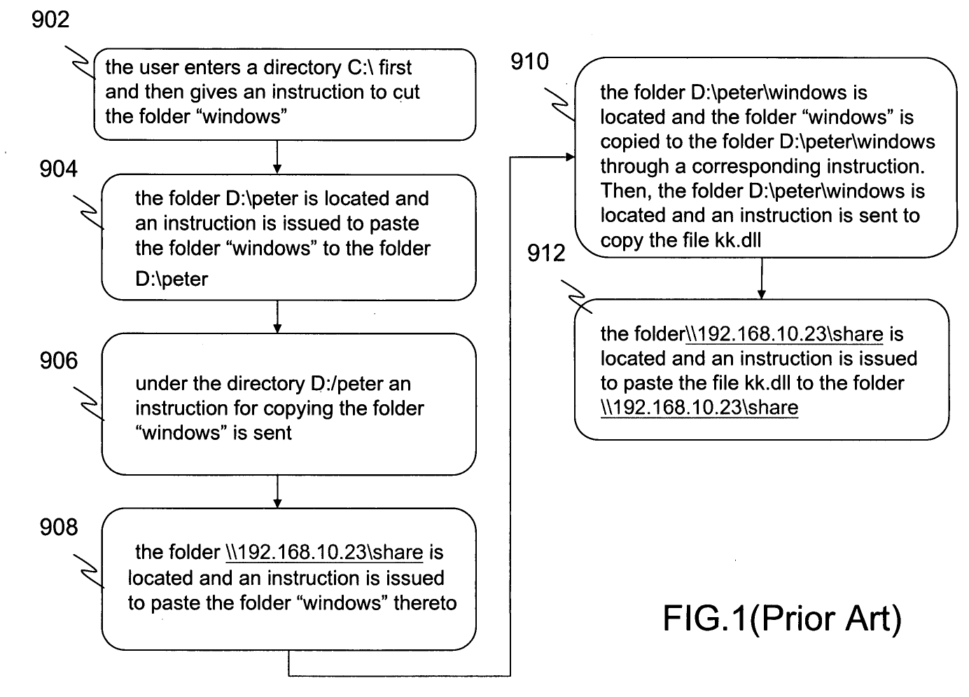

FIG. 2 is a schematic diagram of a user window interface according to the invention;

FIG. 2A is a schematic diagram of a first example of connection lines connected between a plurality of data articles and a plurality of target positions to which the data articles are to be moved;

FIG. 2B is a schematic diagram of a second example of connection lines connected between a plurality of data articles and a plurality of target positions to which the data articles are intended to be moved;

FIG. 3 is a flowchart of a method of moving a single data article to a plurality of target positions according to another embodiment of the invention;

FIG. 4 is a flowchart of a method of moving a plurality of data articles to a single target position according to another embodiment of the invention; and

FIG. 5 is a flowchart of the method according to the invention.

### DETAILED DESCRIPTION OF THE INVENTION

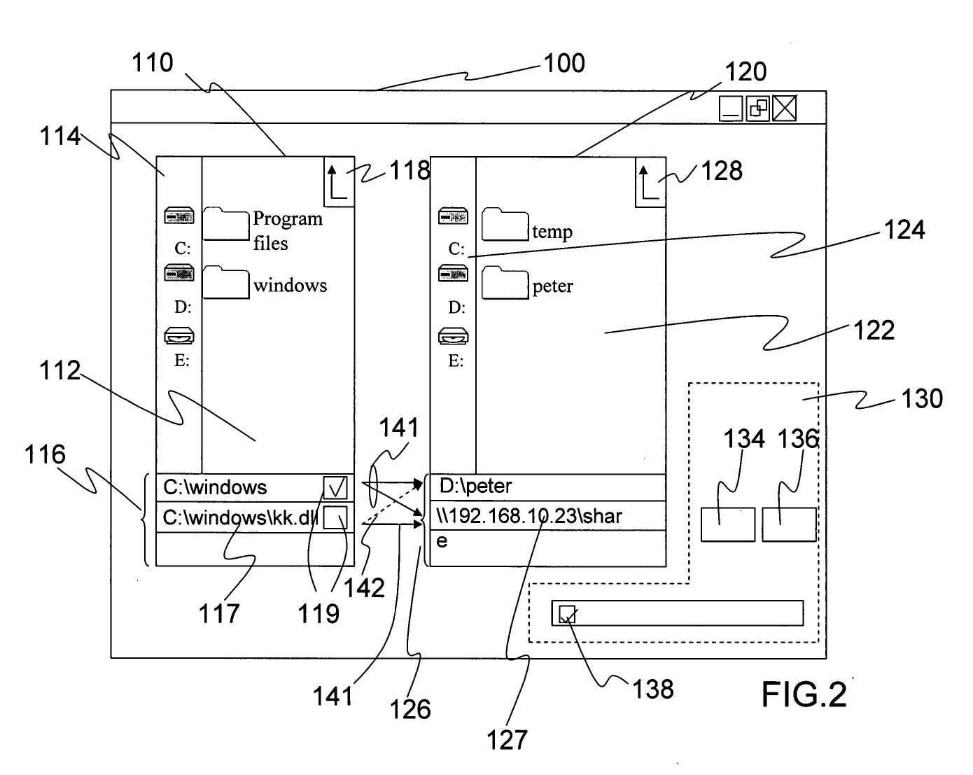

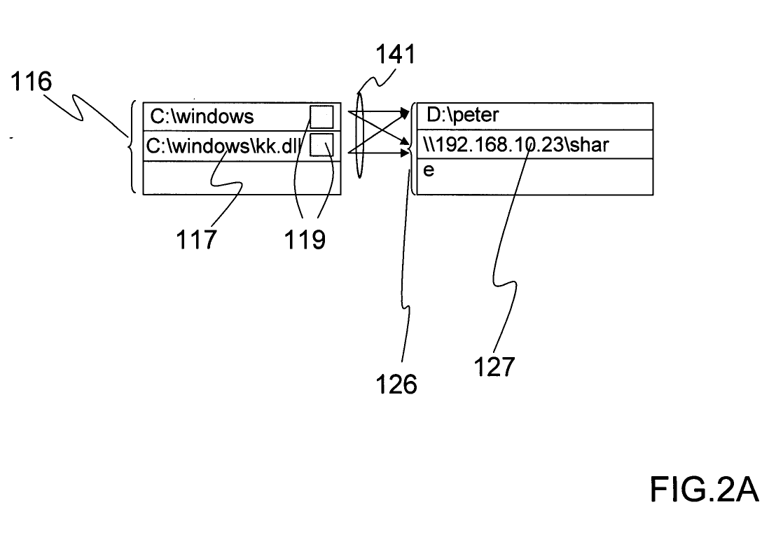

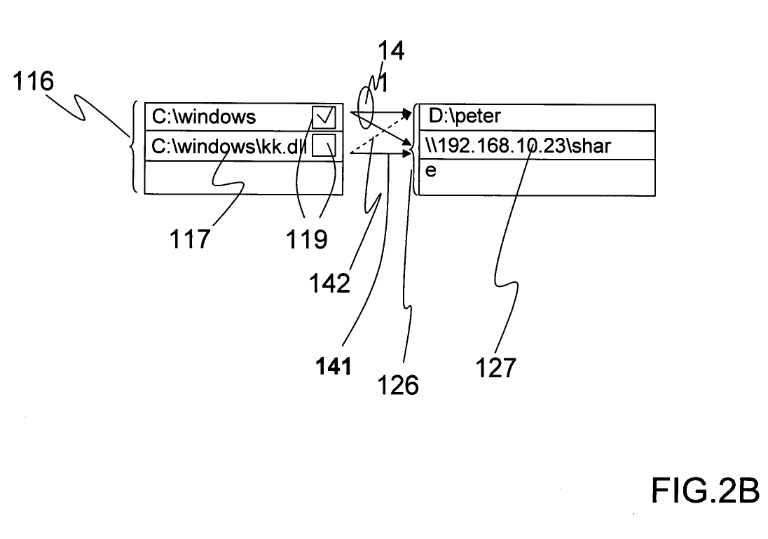

FIG. 2 depicts a user window interface 100 of the invention. The user window interface 100 is an operating system (OS) such as Microsoft windows, Mac, and the like, which has a window form and is operated with a mouse or the like so as to facilitate operations conducted thereon. The user window interface 100 has several frames. Among them, a data source area 110, a data target area 120 and an instruction control area 130 are three main areas. The data source area 110 comprises a source directory frame 112, a source disk indication frame 114, and a source display frame 116. The data target area 120 comprises a target directory frame 122, a target disk frame 124, and a target display frame 126. The instruction control area 130 comprises a confirmation button 134, a cancel button 136 and a small square frame 138.

When the user window interface 100 is opened, the source directory frame 112 in the data source area 110 displays a plurality of folders, each comprising sub-folders and files. When a user wishes to access files in one of the sub-folders, s/he may make two quick left clicks on the sub-folder with a mouse. When the user wishes to select a folder in which the sub-folder resides, s/he may click an up-folder button 118 at the upper-right position of the data source area 100. The source disk indication frame 114 is used for disk switching. Upon being clicked, content displayed by the source disk indication frame 114 may be changed from the current disk directory to another disk directory as selected or clicked, such as a floppy directory A:\, a CD-ROM directory E:\ or a distant directory or file that may be accessed through a network. Furthermore, recently selected directories and files may be displayed in the source disk indication frame 114 to facilitate data moving by the user. A source display frame 116 is provided at a lower portion of the source directory frame 112 and the source disk indication frame 114. In the source display frame 116, all selected files or folders 117 may be displayed; the displayed files or folders 117 are hereinafter termed data articles 117. Preferably, attributes associated with the data articles 117 in the source display frame 116 may be exhibited, such as their file names, sub-file names and paths, so that the user can know any data article 117 that s/he has selected. In selecting a folder in the source directory frame 112 to be a data article 117, the folder may also be dragged directly to the source display frame 116. On the other hand, a file in the source directory frame 112 may also be dragged to the source display frame 116 to become a data article 117, which may be alternatively done by two quick left clicks of the mouse. Upon being selected as the file or folder (data article) to be moved, a next file or folder to be moved may be selected in the source directory frame 112 or the source display frame 114. If wanting to delete a selected data article 117 in the source display frame 116, two quick left clicks of the mouse on the data article 117 are conducted.

After the data articles 117 in the source directory frame 112 are selected and then displayed in the source display frame 116, small square deleting frames 119 are displayed in the source display frame 116, following the data articles 117 respectively. This small square deleting frame 119 may have a default status as being selected or non-selected. In the case of not-selected, the small square deleting frame 119 may be selected with the mouse by a single click, and the data articles in their original positions are deleted after all instructions are performed. Otherwise, the data articles in the original positions are maintained and the moving of data articles is a copying operation.

In the data target area 120, target positions to which the data articles will be moved are displayed, such as a target folder position, a target disk position, a network disk position, or a network folder position. As mentioned, the network disk position or the network file position may be accessed through the Internet or a local network. If the user wishes to enter a sub-folder, the user may enter the sub-folder by clicking twice, and if wishing to enter an upper folder, the upper layer button 128 at the upper part of the target directory frame 122 may be clicked and thus the user may enter the upper folder.

A target display frame 126 is provided below the target directory frame 122 and the target disk indication frame 124 in the user window interface 100. In the target display frame 126, target positions 127 selected in the target directory frame 122 are displayed so that the user can know the selected target positions 127. If the selected target positions 127 are not in the local computer, complete paths thereof are also displayed. If the selected item in the target directory is a folder, the folder may be dragged with the mouse to the target display frame 126 as a target position 127. If a target position 127 is to be deleted from the target display frame 126, the user may delete it with two quick left clicks of the mouse. After selection of the data articles is finished, the instruction control area 130 is operated to select an instruction for the moving data.

In the instruction control area 130, there is a confirmation button 134, a cancel button 136 and a small square frame 138. Upon selection of the confirmation button 134, the data articles 117 displayed in the source display frame 116 are moved one by one to the target positions 127 displayed in the target display frame 126. In the moving operation, a window (not shown) pops up in which rate of progress and time required for moving the data articles 117 are shown. If the user wishes to abort the moving process, s/he may select the cancel button 136 to close the user window interface 100. The instruction control area 130 further comprises a small square frame 138 for determining whether the user window interface 100 will still be used. If the user chooses to use the user window interface 100 after data moving is finished, s/he may select the small square frame 138 to turn the default setting thereof from “selection” to “non-selection”. Otherwise, the user window interface 100 is closed when data moving is finished.

Connection lines are drawn on the user window interface 100 between a plurality of data articles 117 and a plurality of target positions 127 intended to accommodate the data articles 117 being moved, so that the user may easily understand the relationships between them. Solid lines 141 are shown on the user window interface 100 to indicate that each of the data articles 117 are being moved to corresponding target positions 127 so that the user can know the status of data moving. Once the data articles 117 and their target positions 127 are selected, each of the selected data articles is connected on the user window interface 100 to the corresponding target position 127 by the respective connection line. If the user wishes to cancel a moving operation from one of the data articles 127 to one of the target positions 127, s/he may click the corresponding solid line 141 with the mouse. Then, this moving operation is aborted and the solid line 141 becomes a dotted line with lighter color.

FIG. 2A is a schematic diagram of connection lines connecting a plurality of data articles and a plurality of target positions intended to accommodate the plurality of data articles after they are moved. Once two target positions D: \peter and \\192.168.10.23\share 127 are selected in the target display frame 126, data articles C:\windows and C:\windows\kk.dll 117 in the source display frame 116 are connected by solid lines to the target positions D: \peter and \\192.168.10.23\share 127. Now, another case is described with reference to FIG. 2B, where a data article C:\windows is intended to be cut and pasted into a target folder D:\peter and copied into a network folder \\192.168.10.23\share, and a source file C:\windows\kk.dll is intended to be copied into a network folder \\192.168.10.23\share. To cut the folder C:\windows, the small square canceling frame 119 is selected so that the data article C:\windows may be cut from its original position after being moved. Since the file C:\windows\kk.dll only has to be moved to the network folder \\192.168.10.23\share but not moved to the folder D:\peter, a solid line 141 connected between the folders C:\windows\kk.dll and D:\peter is clicked one time and then turned into a dotted line 142 with lighter color. As such, the data article C:\windows\kk.dll is not be moved to the folder D:\peter. If the solid line 142 and thus the data moving operation are to be resumed, the user may simply make a single click of the mouse on the dotted line 142. The solid line 141 returns and the data moving is conducted upon being clicked with the mouse.

Herein, each of the selected data articles are moved to one of the target positions 127 connected thereto by one of the connection lines 141. The data articles 117 followed by the small square deleting frame 119 being selected are deleted only when all the selected data articles 117 are moved. As such, it never happens that the file kk.dll is not located in the folder C:\windows after the folder C:\windows is cut. That is, the paths of the to-be-moved data articles may not be lost during the moving operation thereof.

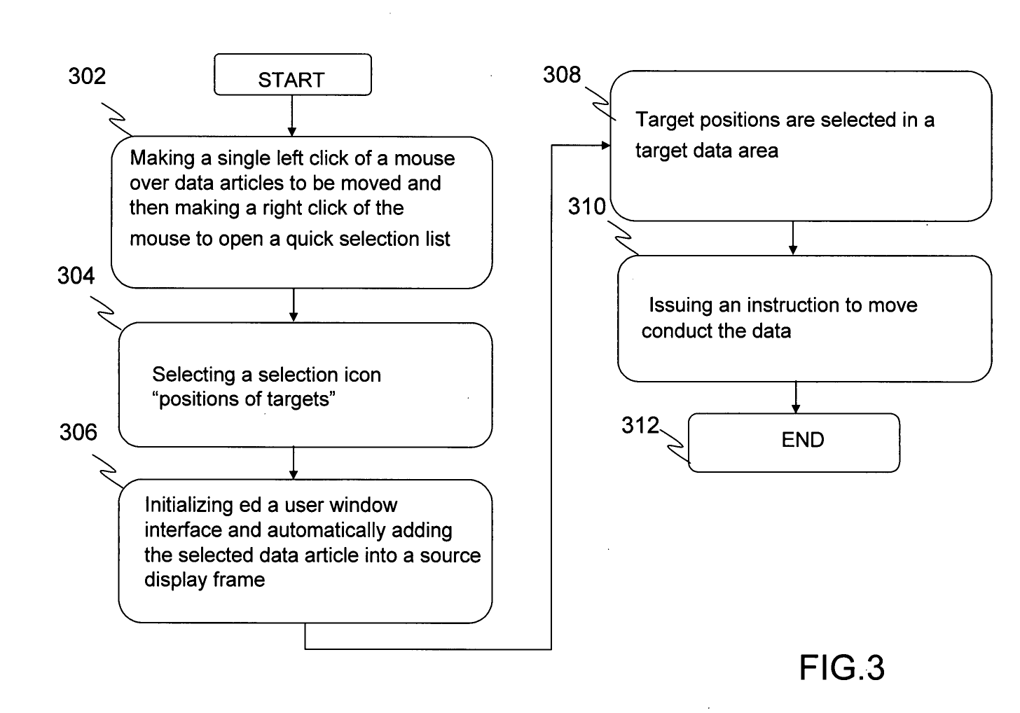

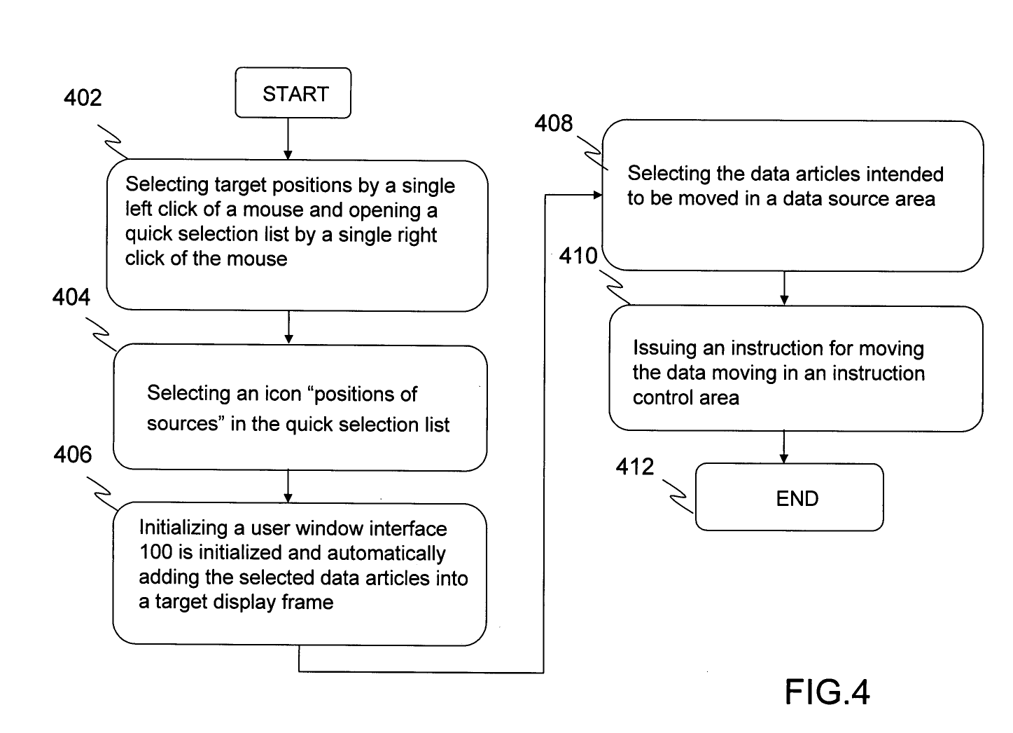

The invention may have many other embodiments. The data moving operations may be conducted on the condition that the user window interface is not opened. In one embodiment, after the software of the user window interface is installed, two selection icons “positions of targets” and “positions of sources” are shown. FIG. 3 is a flowchart of a method of moving a single data article to a plurality of target positions according to another embodiment of the invention, and FIG. 4 is a flowchart of a method of moving a plurality of data articles to a single target position according to another embodiment of the invention. In FIG. 3, when a user window interface 100 is not opened, the user first makes a single left click with a mouse over data articles to be moved, and then makes a right click of the mouse to open a quick selection list (Step 302). Next, the user selects the icon “positions of targets” (Step 304). Then, the user window interface 100 is initialized and the selected data article is automatically added into a source display frame (Step 306). Target positions are selected in a target data area (Step 308). An instruction in an instruction control area is issued to conduct the data moving (Step 310). Finally, the data moving between the single data article and the plurality of target positions is finished (Step 312). Likewise, in FIG. 4 target positions may be selected by a single left click of a mouse and a quick selection list may be opened by a single right click of the mouse (Step 402). An icon “positions of sources” in the quick selection list is selected (Step 404). The user window interface 100 is initialized and the selected data articles are automatically added into a target display frame (Step 406). The data articles to be moved are selected in a data source area (Step 408). An instruction for data moving is issued in an instruction control area (Step 410). Finally, the data moving operation between the plurality of data articles and the single target position is finished (Step 412).

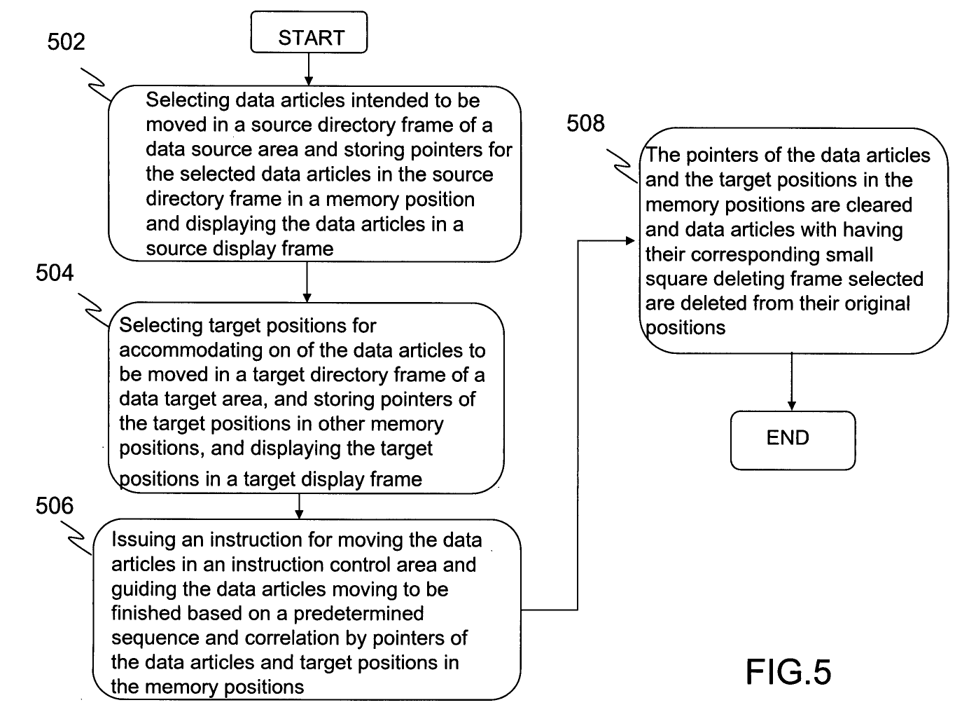

FIG. 5 illustrates an embodiment of the method of the invention. As shown, data articles to be moved are selected in a source directory frame of a data source area, pointers for the selected data articles in the source directory frame are stored in a memory position, and the data articles are displayed in a source display frame (Step 502). Target positions for accommodating the data articles 117 to be moved are selected in a target directory frame 122 of a data target area 120, pointers of the target positions are stored in other memory positions, and the target positions are displayed in a target display frame 126 (Step 504). An instruction for moving the data articles is issued in an instruction control area and pointers of the data articles and target positions stored in the memory positions finish the moving of the data articles based on a predetermined sequence and correlation (Step 506). The pointers of the data articles and the target positions in the memory positions are cleared and data articles with their corresponding small square deleting frame selected are deleted from their original positions (Step 508).

When the invention is applied to mobile phones, personal digital assistants (PDAs) or other devices, the data article 117 is a message, a communication book, a calendar or the like and the target position is a storage area of a home computer, another handheld device or the like, which may be connected through cables, bluetooth devices or networks. With the user window interface and the method of data moving of the invention, data or files in the message, communication book and calendar folders may be easily moved to one or a plurality of target positions.

While embodiments and applications of the invention have been shown and described, it will be apparent to those skilled in the art having the benefit of this disclosure that many more modifications than mentioned above are possible without departing from the spirit and scope of the invention. The invention, therefore, is not to be restricted except in the spirit of the appended claims and their equivalents.

1. A user window interface through which a user moves at least a data article at the same time to at least a target position, comprising:
a data source area, comprising:
a source directory frame in which the at least a data article is selected; and
a source display frame on which the at least a data article selected in the source directory frame is displayed;
a data target area, comprising:
a target directory frame on which the target position for accommodation of the at least a data article intended to be moved is selected; and
a target display frame used to display the at least a target position having been selected; and
an instruction control area having a plurality of instruction control buttons for issuing an instruction for moving the at least a target position.

2. The user window interface of claim 1, wherein the user window interface is capable of being opened and executed in an operating system (OS) of a computer or a handheld device.

3. The user window interface of claim 1, wherein the at least a data article is a folder or a file.

4. The user window interface of claim 1, wherein the at least a target position is one of a disk position, a folder position, a network disk position and a network folder position.

5. The user window interface of claim 1, wherein the source display area further displays a complete path, a file name and a filename extension of the at least a data article.

6. The user window interface of claim 1, wherein the target display area further displays a complete path of the target position.

7. The user window interface of claim 1, wherein the plurality of buttons comprises a confirmation button and a cancel button.

8. The user window interface of claim 1, wherein a relationship between the at least a data article and the target position is displayed by a connection line therebetween.

9. The user window interface of claim 1, wherein a small square deleting frame is provided at a location following the data article in the source display frame.

10. A method of moving at least a data article at the same time to at least a target position, comprising the steps of:
providing a data source area comprising a source directory frame and a source display frame;
selecting the at least a data article in the source directory frame and storing a pointer of the at least a data article in a memory position;
displaying the at least a data article in the source display frame;
providing a data target area comprising a target directory frame and a target display frame;
selecting the at least a target position in the target directory frame and storing a pointer of the at least a target position having been selected in another memory position;
providing an instruction control area comprising a plurality of buttons for moving the at least a data article; and
selecting an instruction in the instruction control area through the plurality of buttons to move the at least a data article to the at least a target position.

11. The method of claim 10, wherein the data article is a folder or a file.

12. The method of claim 11, wherein the folder is added to the source display frame by being dragged.

13. The method of claim 11, wherein the file is added to the source display frame by being dragged or selected.

14. The method of claim 10, wherein the target position is one of a disk position, a folder position, a network disk position and a network folder position.

15. The method of claim 14, wherein the network disk position and the network folder position are each accessed through the Internet or a local network.

16. The method of claim 10, wherein the target position is a storage position of a home computer or a handheld device.

17. The method of claim 10, wherein the method is performed by opening a user window interface through a quick selection list, wherein the single data article is added automatically to the source display frame.

18. The method of claim 10, wherein the method is performed by opening a user window interface through a quick selection list, wherein the single target position is added automatically to the target display frame.
